(19) United States
(12) Patent Application Publication
(10) Pub. No.: US 2012/0325098 A1
(43) Pub. Date: Dec. 27, 2012

(54) PRINTING BLANKET, MANUFACTURING METHOD THEREOF, BLANKET CYLINDER, AND PRINTING PRESS

(75) Inventors: Koji Nishiyama, Mihara-shi (JP); Takashi Mori, Mihara-shi (JP)

(73) Assignees: KYOCERA CORPORATION, Fushimi-ku, Kyoto (JP); MITSUBISHI HEAVY INDUSTRIES PRINTING & PACKAGING MACHINERY, LTD., Mihara-shi, Hiroshima (JP)

(21) Appl. No.: 13/521,079

(22) PCT Filed: Feb. 24, 2010
(86) PCT No.: PCT/JP2010/052881

§ 371 Date: Jul. 9, 2012

(51) Int. Cl. B41F 13/10; B41C 3/08

(52) U.S. Cl. 101/375; 101/401.1

(57) ABSTRACT

In a printing blanket, a manufacturing method of the printing blanket, a blanket cylinder, and a printing press, a printing unit is configured to include a plate cylinder to which a plate is attached, and a blanket cylinder that has a blanket attached thereto, rotates synchronously with the plate cylinder, and can transfer an ink image transferred from the plate cylinder onto a web, a circumference of the blanket cylinder is set to be twice as large as a circumference of the plate cylinder, and a notch and a concave portion along an axial direction are provided on a surface of the blanket at a uniform interval to correspond to a notch of the plate cylinder.

### FIELD

The present invention relates to a printing blanket that is attached to an outer circumferential portion of a blanket cylinder and that can transfer an ink image onto a printing medium, a method of manufacturing the printing blanket, a blanket cylinder to which the printing blanket is attached, and a printing press to which the printing blanket is applied.

### BACKGROUND

For example, a general newspaper web offset printing press is configured to include a plurality of feeder units, a plurality of printing units, a turn bar device, and a folding machine. When a web is fed from each of the feeder units to one of the printing units, a printing operation is performed on each web, the turn bar device changes traveling routes of many webs and superimposes the webs in a predetermined order, the folding machine folds the webs vertically and horizontally, cuts the vertically folded webs by a predetermined length, horizontally folds the cut webs, thereby forming a quire and delivering the quire.

Each of the printing units included in the newspaper web offset printing press is constituted as an H-shaped tower unit to make four-color printing. The printing unit is configured to include four stacks A, B, C, and D for black, cyan, magenta, and yellow, respectively, which are arranged vertically. The stacks are substantially identical in configuration, and bilaterally symmetric about the webs that run upward. Each stack is configured so that a blanket cylinder, a plate cylinder, an ink application roller, a plurality of ink rollers, and an inking device are provided in series.

In this type of printing unit, the blanket cylinder and the plate cylinder are normally double diameter cylinders, and the both cylinders are identical in diameter and circumference. However, if the plate cylinder is the double diameter cylinder, two plates are necessary to be provided. Therefore, for cost reduction, there is proposed a printing unit configured so that a blanket cylinder is a double diameter cylinder and that a plate cylinder is a single diameter cylinder.

For example, Patent Literature 1 mentioned below describes such a conventional printing unit.

### CITATION LIST

### Patent Literature

Patent Literature 1: Japanese Patent No. 3554303

### SUMMARY

### Technical Problem

Meanwhile, a sheet-like plate is attached to an outer circumferential portion of a plate cylinder, and this plate is constrained by a plate clamping device the longitudinal end portions of which are accommodated in a notch of the plate cylinder. On the other hand, a sheet-like blanket is attached to the outer circumferential portion of the blanket cylinder, and this plate is constrained by a blanket clamping device the longitudinal end portions of which are accommodated in the notch of the blanket cylinder.

In this case, when the blanket cylinder and the plate cylinder are double diameter cylinders, rotation phases of the blanket cylinder and the plate cylinder are adjusted so that the notches always match each other during the rotation of the respective cylinders because the cylinders have the identical circumference. This can prevent ink residues accumulated in the notch of the plate cylinder from being transferred onto the blanket cylinder. However, when the blanket cylinder is a double diameter cylinder and the plate diameter is a single diameter cylinder, the plate diameter rotates twice when the blanket cylinder rotates once because of the difference in the circumference. This prevents the notches of the respective cylinders from being always aligned and the ink residues accumulated in the notch of the plate cylinder is transferred onto the blanket cylinder. As a result, the ink residues transferred onto the blanket cylinder are transferred onto each web, which disadvantageously stains the outer circumferential portion of the web.

The present invention has been achieved to solve the above problems, and an object of the present invention is to provide a printing blanket, a manufacturing method of the printing blanket, a blanket cylinder, and a printing press that can suppress transfer of ink residues from a plate cylinder onto the blanket cylinder and that can improve the printing quality.

### Solution to Problem

According to an aspect of the present invention, a printing blanket that is attached to an outer circumferential portion of a rotating body, and is capable of transfer an ink image onto a printing medium, includes a concave portion that is disposed along an axial direction of the rotating body at a predetermined position on a surface of the printing blanket.

Advantageously, in the printing blanket, the printing blanket has a sheet-like shape and includes a clamped portion that can be clamped to the rotating body and that is provided in each end portion of the printing blanket in a longitudinal direction, and the concave portion is provided at an intermediate position in the longitudinal direction or at a uniform interval position in the longitudinal direction.

Advantageously, in the printing blanket, the printing blanket has a cylindrical shape and includes a clamped portion that can be fitted into and clamped to the rotating body, and a plurality of concave portions are provided on a surface of the printing blanket at a uniform interval in a circumferential direction.

Advantageously, the printing blanket further includes: a base portion that can be clamped to the rotating body; and an elastic layer provided on a surface of the base portion. The concave portion is provided on a surface of the elastic layer.

Advantageously, the printing blanket further includes: a base portion that can be clamped to the rotating body; and a plurality of elastic layers provided on a surface of the base portion at a predetermined interval in a longitudinal direction. The concave portion is provided among the elastic layers.

Advantageously, the printing blanket further includes: a base portion that can be clamped to the rotating body; and an elastic layer provided on a surface of the base portion. A thin-walled portion is provided at a predetermined position of the base portion, and the thin-walled portion causes the elastic layer to deform, thereby forming the concave portion.

According to another aspect of the present invention, a method of manufacturing a printing blanket that is attached to an outer circumferential portion of a rotating body and is capable of transferring an ink image onto a printing medium, includes: providing an elastic layer on a surface of a base portion that can be clamped to the rotating body; and cutting the elastic layer at a predetermined longitudinal position in a width direction, thereby forming a concave portion and manufacturing the printing blanket.

According to still another aspect of the present invention, a method of manufacturing a printing blanket that is attached to an outer circumferential portion of a rotating body and is capable of transferring an ink image onto a printing medium, includes providing elastic layers on a surface of a base portion that can be clamped to the rotating body at a predetermined interval in a longitudinal direction, thereby forming a concave portion along a width direction and manufacturing the printing blanket.

According to still another aspect of the present invention, a blanket cylinder that rotates synchronously with a plate cylinder, is capable of transferring an ink image transferred from the plate cylinder onto a printing medium, and has a circumference set to an integer multiple of a circumference of the plate cylinder, includes a plurality of concave portions disposed along an axial direction are provided on a surface of the blanket cylinder at a uniform interval to correspond to a position of the plate cylinder at which a plate is clamped.

Advantageously, in the blanket cylinder, each longitudinal end portion of a sheet-like blanket is clamped to an outer circumferential portion of a blanket-cylinder main body, a clamping mechanism that clamps each end portion of the blanket to the blanket-cylinder main body is accommodated in at least one of the concave portions, and the remaining concave portions are provided on a surface of the blanket.

Advantageously, in the blanket cylinder, a cylindrical blanket is fitted in and clamped to an outer circumferential portion of a blanket-cylinder main body, and the concave portions are provided on a surface of the blanket.

Advantageously, in the blanket cylinder, a plurality of sheets are attached to an outer circumferential portion of a blanket-cylinder main body at a predetermined gap formed among the sheets in a circumferential direction, a blanket is attached to a surface of the sheets, and the gap among the sheets causes the blanket to deform, thereby forming the concave portions.

Advantageously, in the blanket cylinder, a circumferential length of each of the concave portions is set to be larger than a circumferential length of a notch formed in a plate clamped portion of the plate cylinder.

According to still another aspect of the present invention, a printing press includes: a plate cylinder to which a plate is attached; and a blanket cylinder that has a blanket attached thereto, rotates synchronously with the plate cylinder, and can transfer an ink image transferred from the plate cylinder onto a printing medium. A circumference of the blanket cylinder is set to an integer multiple of a circumference of the plate cylinder, and a plurality of concave portions along an axial direction are provided on a surface of the blanket at a uniform interval to correspond to a position of the plate cylinder at which the plate is clamped.

### Advantageous Effects of Invention

According to the printing blanket of the present invention, the printing blanket is configured to be attached to the outer circumferential portion of the rotating body, and to be capable of transferring the ink image onto the printing medium, and configured so that the concave portion along the axial direction of the rotating body is provided at a predetermined position on the surface of the printing blanket. It is thereby possible to suppress ink residues from being transferred from the plate cylinder onto the blanket cylinder, and to improve the printing quality.

According to the printing blanket of the present invention, the printing blanket has a sheet-like shape, the printing blanket includes the clamped portion that can be clamped to the rotating body and that is provided in each end portion of the printing blanket in the longitudinal direction, and the concave portion is provided at the intermediate position in the longitudinal direction or at the uniform interval position in the longitudinal direction. Therefore, it is possible to easily form the concave portion.

According to the printing blanket of the present invention, the printing blanket has a cylindrical shape, the printing blanket includes the clamped portion that can be fitted into and clamped to the rotating body, and a plurality of concave portions are provided on the surface of the printing blanket at a uniform interval in the circumferential direction. Therefore, it is possible to easily form the concave portions.

According to the printing blanket of the present invention, the printing blanket includes the base portion that can be clamped to the rotating body, and the elastic layer provided on the surface of the base portion, and the concave portion is provided on the surface of the elastic layer. Therefore, the base portion can ensure a predetermined rigidity, and the elastic layer can ensure ink transfer characteristics. Furthermore, by providing the concave portion on the surface of this elastic layer, the concave portion can be formed with high positioning accuracy.

According to the printing blanket of the present invention, the printing blanket includes the base portion that can be clamped to the rotating body, and a plurality of elastic layers provided on a surface of the base portion at a predetermined interval in the longitudinal direction, and the concave portion is provided among the elastic layers. Therefore, the base portion can ensure a predetermined rigidity, and the elastic layer can ensure ink transfer characteristics. Furthermore, by providing the concave portions on the surface of this elastic layer, the concave portions can be formed with high positioning accuracy.

According to the printing blanket of the present invention, the printing blanket includes the base portion that can be clamped to the rotating body, and the elastic layer provided on the surface of the base portion, the thin-walled portion is provided at a predetermined position of the base portion, and the thin-walled portion causes the elastic layer to deform, thereby forming the concave portion. Therefore, by forming the concave portion in the elastic layer by the use of the thin-walled portion of the base portion, the concave portion can be easily formed without changing a shape of the elastic layer, and the durability of the elastic layer can be improved.

According to the method of manufacturing the printing blanket of the present invention, the printing blanket that is attached to the outer circumferential portion of the rotating body and is capable of transferring the ink image onto the printing medium is manufactured by providing the elastic layer on the surface of the base portion that can be clamped to the rotating body, and cutting the elastic layer at a predetermined longitudinal position in the width direction, thereby forming the concave portion. Therefore, it is possible to form the concave portion with high positioning accuracy.

According to the method of manufacturing the printing blanket of the present invention, the printing blanket that is attached to the outer circumferential portion of the rotating body and is capable of transferring the ink image onto the printing medium is manufactured by providing the elastic layers on the surface of the base portion that can be clamped to the rotating body at a predetermined interval in the longitudinal direction, thereby forming the concave portion along the width direction. Therefore, it is possible to easily form the concave portion.

According to the blanket cylinder of the present invention, the blanket cylinder is configured to rotate synchronously with the plate cylinder, to be capable of transferring the ink image transferred from the plate cylinder onto the printing medium, and to have the circumference set to the integer multiple of the circumference of the plate cylinder, and a plurality of concave portions along the axial direction are provided on the surface of the blanket cylinder at a uniform interval to correspond to the position of the plate cylinder at which the plate is clamped. Therefore, when the plate cylinder and the blanket cylinder rotate, the position of the plate cylinder at which the plate is clamped faces the concave portions of the blanket cylinder. It is thereby possible to suppress the ink residues from being transferred from the plate cylinder onto the blanket cylinder, and to improve the printing quality.

According to the blanket cylinder of the present invention, each longitudinal end portion of the sheet-like blanket is clamped to the outer circumferential portion of the blanket-cylinder main body, the clamping mechanism that clamps each end portion of the blanket to the blanket-cylinder main body is accommodated in at least one of the concave portions, and the remaining concave portions are provided on the surface of the blanket. By using the portion that accommodates the blanket clamping mechanism as one of the concave portions, it is possible to make the blanket cylinder simple in configuration.

According to the blanket cylinder of the present invention, the cylindrical blanket is fitted in and clamped to the outer circumferential portion of the blanket-cylinder main body, and the concave portions are provided on the surface of the blanket. Therefore, it is possible to easily form the concave portion.

According to the blanket cylinder of the present invention, a plurality of sheets are attached to the outer circumferential portion of the blanket-cylinder main body at a predetermined gap formed among the sheets in the circumferential direction, the blanket is attached to the surface of the sheets, and the gap among the sheets causes the blanket to deform, thereby forming the concave portions. Therefore, by forming the concave portions in the blanket by the use of the gap between the sheets, the concave portions can be easily formed without changing the shape of the blanket, and the durability of the elastic layer can be improved.

According to the blanket cylinder of the present invention, the circumferential length of each of the concave portions is set to be larger than the circumferential length of the notch formed in the plate clamped portion of the plate cylinder. Therefore, it is possible to suppress the ink residues from being transferred from the plate cylinder onto the blanket cylinder without the contact of the notch of the plate cylinder with the outer circumferential surface of the blanket cylinder.

According to the printing press of the present invention, the printing press includes the plate cylinder to which the plate is attached, and the blanket cylinder to which the blanket is attached, that rotates synchronously with the plate cylinder, and that can transfer the ink image transferred from the plate cylinder onto the printing medium, the circumference of the blanket cylinder is set to the integer multiple of the circumference of the plate cylinder, and a plurality of concave portions along the axial direction are provided on the surface of the blanket at a uniform interval to correspond to the position of the plate cylinder at which the plate is clamped. Accordingly, when the plate cylinder and the blanket cylinder rotate, the position of the plate cylinder at which the plate is clamped faces the concave portions of the blanket cylinder. It is thereby possible to suppress the ink residues from being transferred from the plate cylinder onto the blanket cylinder, and to improve the printing quality.

### BRIEF DESCRIPTION OF DRAWINGS

FIG. 1 is a schematic diagram of a blanket cylinder and a plate cylinder according to a first embodiment of the present invention.

FIG. 2 is a schematic diagram of a printing blanket according to the first embodiment.

FIG. 3 is a schematic diagram of a printing unit to which the blanket cylinder according to the first embodiment is applied.

FIG. 4 is a schematic diagram of a newspaper web offset printing press according to the first embodiment.

FIG. 5 is a schematic diagram of a printing blanket according to a second embodiment of the present invention.

FIG. 6 is a schematic diagram of a printing blanket according to a third embodiment of the present invention.

FIG. 7 is a schematic side view of a blanket cylinder according to a fourth embodiment of the present invention.

FIG. 8 is a schematic side view of a blanket cylinder according to a fifth embodiment of the present invention.

FIG. 9 is a schematic side view of a blanket cylinder according to a sixth embodiment of the present invention.

### DESCRIPTION OF EMBODIMENTS

Exemplary embodiments of a printing blanket, a manufacturing method of the printing blanket, a blanket cylinder, and a printing press according to the present invention will be explained below in detail with reference to the accompanying drawings. The present invention is not limited to the embodiments.

### First Embodiment

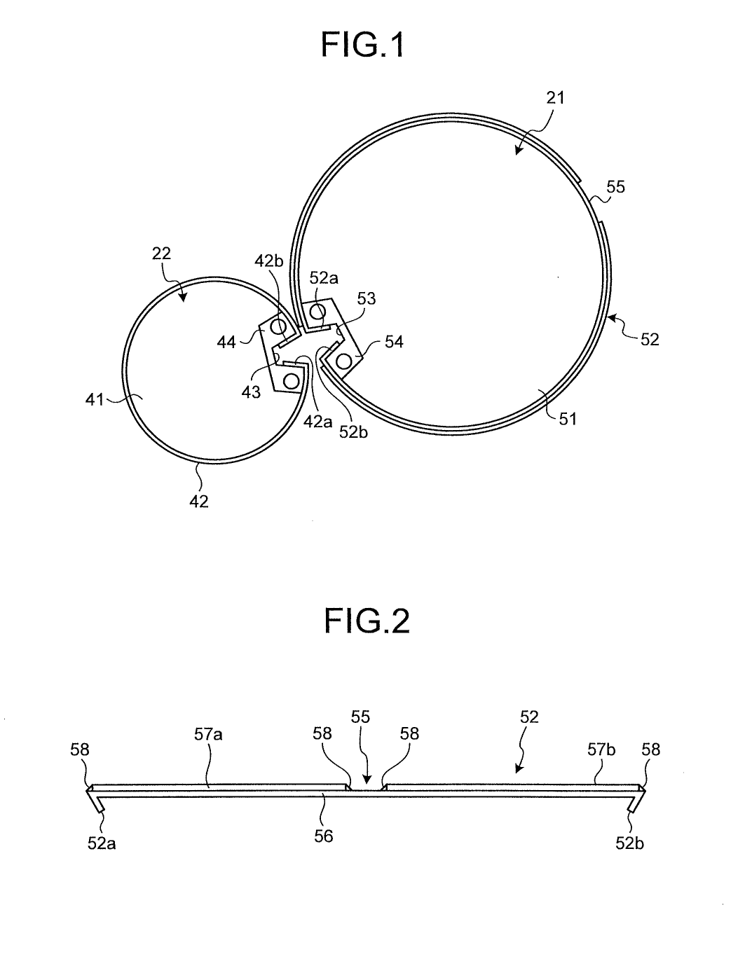

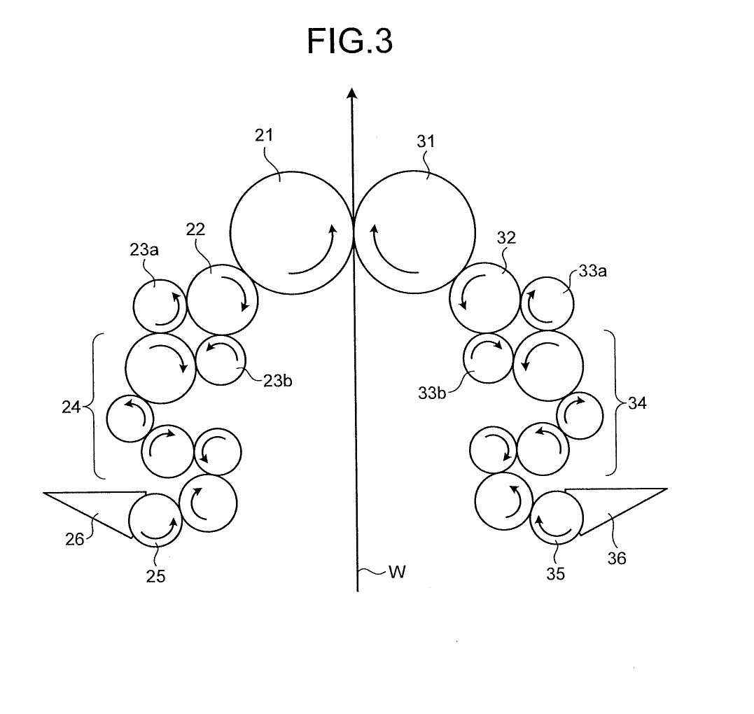

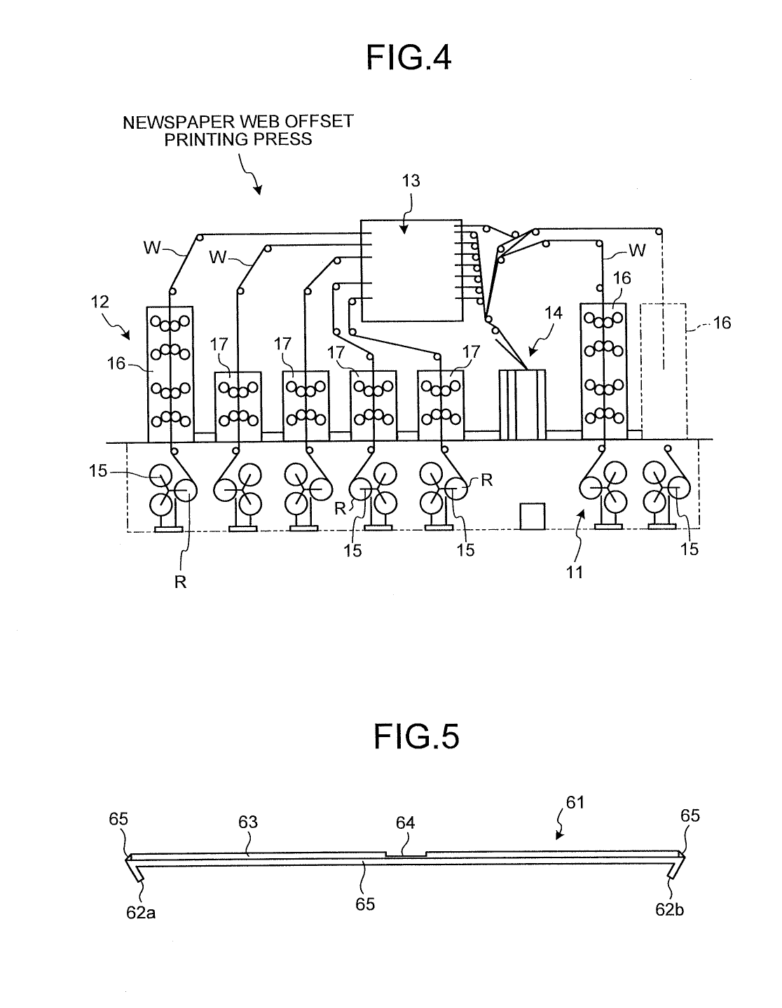

FIG. 1 is a schematic diagram of a blanket cylinder and a plate cylinder according to a first embodiment of the present invention, FIG. 2 is a schematic diagram of a printing blanket according to the first embodiment, FIG. 3 is a schematic diagram of a printing unit to which the blanket cylinder according to the first embodiment is applied, and FIG. 4 is a schematic diagram of a newspaper web offset printing press according to the first embodiment.

In the first embodiment, the newspaper web offset printing press applied as a printing press is configured to include a feeder device 11, a printing device 12, a turn bar device 13, and a folding machine 14, as shown in FIG. 4. A plurality of holding arms 15 each of which holds three paper rolls R that are rolled webs (sheets) W are provided in the feeder device 11. The feeder device 11 can rotate the paper rolls R up to feeding positions by rotating the respective holding arms 15. Furthermore, a paper splicing device (not shown) is provided in this feeder device 11. When each paper roll R unreeled at the feeding position is running short, the paper splicing device can splice another paper roll R at a waiting position to the paper roll R at the feeding position.

Multicolor printing units 16 each of which performs a double-sided four-color printing operation and two-color printing units 17 each of which performs a double-sided two-color printing operation are provided in the printing device 12. Each of these multicolor printing units 16 and two-color printing units 17 can perform a predetermined printing operation on each web W fed from the feeder device 11. While the printing device 12 is configured to include the multicolor printing units 16 and the two-color printing units 17 in the present embodiment, the configuration of the printing device 12 is not limited to that described here. For example, it suffices to use an appropriate combination of various units such as double-sided single-color printing units each of which performs a double-sided single-color printing operation and multicolor printing units each of which performs a one-sided four-color or two-color printing operation depending on printed matters.

A plurality of turn bars (not shown) are provided in the turn bar device 13. The turn bar device 13 can change traveling routes of the respective webs W fed from the printing units 16 and 17 and superimposes the webs W. The folding machine 14 is designed to vertically fold the webs W transported from the turn bar device 13, horizontally cut the webs W each by a predetermined length, further horizontally hold the cut web W, form a desired quire, and then deliver the quire.

Therefore, first, when the feeder device 11 feeds the webs W to the multicolor printing units 16 or the two-color printing units 17 that constitute the printing device 12, each of the printing units 16 or 17 performs the four-color printing or two-color printing operation on each of the webs W. Next, the turn bar device 13 changes the traveling routes of the webs W and superimposes the webs W in a predetermined order. The turn bar device 13 transports the webs W that are superimposed to the folding machine 14. The folding machine 14 vertically folds the webs W, horizontally cuts the vertically folded webs W, further horizontally folds the webs W, thereby forms the desired quire, and delivers the quire onto a delivery conveyer by impellers.

In the printing device 12 included in this newspaper web offset printing press, each of the printing units 16 is constituted as an H-shaped tower unit so as to be able to perform the four-color printing. Each printing unit 16 is configured so that four stacks for black, cyan, magenta, and yellow, respectively, are arranged along a vertically direction. Because the stacks are substantially identical in configuration, one of the stacks is picked up and described here.

As shown in FIG. 3, one of the stacks included in each of the printing units 16 is configured to be bilaterally (two sides) symmetric about the web W traveling upward. That is, paired blanket cylinders 21 and 31 are arranged to face each other and to be able to abut on each other so as to contact a face and a back side of the web W, and plate cylinders 22 and 32 are arranged to abut on the blanket cylinders 21 and 31, respectively. Two ink application rollers 23a and 23b are arranged to abut on one plate cylinder 22, each of the ink application rollers 23a and 23b abuts on an ink source roller 25 via ink rollers 24, and an ink pot 26 is arranged with respect to this ink source roller 25. Two ink application rollers 33a and 33b are arranged to abut on the other plate cylinder 32, each of the ink application rollers 33a and 33b abuts on an ink source roller 35 via ink rollers 34, and an ink pot 36 is arranged with respect to this ink source roller 35.

Accordingly, aqueous ink the feed rate of which is regulated by the ink source rollers 25 and 35 is fed from the ink pots 26 and 36, fed to the ink application rollers 23a, 23b, and 33a, 33b via the ink rollers 24 and 34, and fed to a plate surface of the plate cylinders 22 and 32 from these ink application rollers 23a, 23b, and 33a, 33b, respectively. The ink adhering onto the plate surface is transferred onto the blanket cylinders 21 and 31, respectively. By applying a predetermined printing pressure to the web W between the blanket cylinder 21 that performs a face printing operation and the blanket cylinder 31 that performs a back printing operation, the ink on the respective blanket cylinders 21 and 31 can be transferred onto the face and back side of the web W as a picture, respectively.

The blanket cylinders 21 and 31 and the plate cylinders 22 and 32 in each of the printing units 16 configured as described above are described next. Because the printing unit 16 has a bilaterally symmetric structure, one of the blanket cylinders 21 and 31 and one of the plate cylinders 22 and 32, that is, the blanket cylinder 21 and the plate cylinder 22 are described here.

As shown in FIG. 1, the plate cylinder 22 is configured so that a plate 42 is attached to an outer circumferential portion of a plate-cylinder main body 41. The plate-cylinder main body 41 has a cylindrical shape, a notch 43 along an axial direction of the plate-cylinder main body 41 is formed in a predetermined portion of the outer circumferential portion in a circumferential direction, and a plate clamping device 44 is accommodated in this notch 43. This plate clamping device 44 clamps clamped portions 42a and 42b that are formed by bending longitudinal end portions of the plate 42 to each other. Specifically, the plate clamping device 44 winds this plate 42 around the plate-cylinder main body 41 in a state where the clamped portion 42a that is a gripper-side clamped portion of the plate 42 is retained in the notch 43, and fixes the plate 42 while holding and drawing the gripper-end-side clamped portion 42b.

The blanket cylinder 21 is configured so that a blanket (a printing blanket) 52 is attached to an outer circumferential portion of a blanket-cylinder main body 51. The blanket-cylinder main body 51 has a cylindrical shape, a notch 53 along an axial direction of the blanket-cylinder main body 51 is formed in a predetermined portion of the outer circumferential portion in a circumferential direction, and a blanket clamping device 54 is accommodated in this notch 53. This blanket clamping device 54 clamps clamped portions 52a and 52b that are formed by bending longitudinal end portions of the blanket 52 to each other. Specifically, the blanket clamping device 54 winds this blanket 52 around the blanket-cylinder main body 51 in a state where the clamped portion 52a that is a gripper-side clamped portion of the blanket 52 is retained in the notch 53, and fixes the blanket 52 while holding and drawing the gripper-end-side clamped portion 52b.

This blanket cylinder 21 has the blanket 52 attached to the outer circumferential portion of the blanket-cylinder main body (a rotating body) 51 and rotates synchronously with the plate cylinder 22, whereby the blanket cylinder 21 can transfer an ink image transferred from the plate 42 of this plate cylinder 22 onto each web W. In the first embodiment, a circumference (a diameter) of the blanket cylinder 21 is set to an integer multiple of (twice as large as in the present embodiment) that of the plate cylinder 22. Rotation phases of the blanket cylinder 21 and the plate cylinder 22 are set so that the notches 43 and 53 always match each other when the blanket cylinder 21 and the plate cylinder 22 rotate synchronously.

In the first embodiment, in the blanket cylinder 21, a concave portion 55 along the axial direction of the blanket-cylinder main body 51 is provided on a surface of the blanket 52 attached to the outer circumferential portion of the blanket cylinder 21 to correspond to a position of the plate cylinder 22 at which the plate 42 is clamped, that is, to correspond to the notch 43.

That is, when the ink is transferred onto the plate cylinder 22 and this transferred ink is transferred onto the blanket cylinder 21, ink residues tend to be accumulated in corners between the outer circumferential portion of the plate cylinder 22 and the notch 43. If the ink residues accumulated in the vicinity of the notch 43 of the plate cylinder 22 is transferred onto the blanket cylinder 21, the blanket cylinder 21 transfers even these ink residues onto the web W, which stains an outer circumferential portion of the web W (a frame portion of a sheet of newspaper).

In this case, because of the setting of the circumference of the blanket cylinder 21 to be twice as large as that of the plate cylinder 22, when the blanket cylinder 21 rotates once, the plate cylinder 22 rotates twice. At this time, the notch 43 of the plate cylinder 22 arrives at an opposed position to an outer circumferential surface of the blanket cylinder 21 twice. Therefore, in the present embodiment, a plurality of concave portions are provided in the outer circumferential portion of the blanket cylinder 21 at a uniform interval to correspond to the notch 43 of the plate cylinder 22, thereby preventing the ink residues accumulated in the vicinity of the notch 43 of the plate cylinder 22 from being transferred onto the blanket cylinder 21.

Two concave portions of the blanket cylinder 21 are necessary to be provided, the notch 53 is used as one of the concave portions, and the concave portion 55 described above is provided at the position at which the concave portion 55 faces this notch 53 circumferentially at an angle of 180 degrees with respect to the notch 53. Therefore, when the plate cylinder 22 and the blanket cylinder 21 synchronously rotate and the blanket cylinder 21 rotates once, the plate cylinder 22 rotates twice. At this time, the notch 53 and the concave portion 55 alternately face the notch 43 of the plate cylinder 22, thereby preventing the ink residues accumulated in the vicinity of the notch 43 of the plate cylinder 22 from being transferred onto the blanket cylinder 21.

In this case, it is necessary to set a circumferential length of each of the notch 53 and the concave portion 55 of the blanket cylinder 21 to be larger than that of the notch 43 of the plate cylinder 22. That is, when the notch 43 of the plate cylinder 22 arrives at the opposed position to the notch 53 or the concave portion 55 of the blanket cylinder 21, the corners of the plate cylinder 22 between the outer circumferential portion and the notch 43 are located within the notch 53 or the concave portion 55 of the blanket cylinder 21. The corners do not contact the outer circumferential surface of the blanket cylinder 21, thereby preventing the ink residues from being transferred from the plate cylinder 22 onto the blanket cylinder 21.

Specifically, if it is assumed that a nip width between the blanket cylinder 21 and the plate cylinder 22 is A, the circumferential length of each of the notch 53 and the concave portion 55 of the blanket cylinder 21 is L1, and the circumferential length of the plate cylinder 22 is L2, A, L1, and L2 preferably hold a relation of A>L1>L2.

The blanket 52 of the blanket cylinder 21 is described next in detail. As shown in FIG. 2, the concave portion 55 along the axial direction of the blanket-cylinder main body 51 is provided at a predetermined position of the surface of the blanket cylinder 21, that is, in an intermediate portion in a longitudinal direction (a direction of winding the blanket 52 around the blanket-cylinder main body 51 by one turn) in the present embodiment.

Specifically, the blanket 52 includes a base portion 56 that can be clamped to the blanket-cylinder main body 51, and a plurality of (two in the present embodiment) elastic layers 57a and 57b provided at a predetermined interval on a surface of this base portion 56 in a longitudinal direction. The concave portion 55 is provided between the two elastic layers 57a and 57b. This base portion 56 is a plate material made of metal (steel or aluminum, for example), and the clamped portions 52a and 52b described above are formed by bending longitudinal end portions of the base portion 56, respectively. Alternatively, glass fiber, fiber-reinforced plastic (FRP) the strength of which is reinforced by containing this glass fiber in plastic or the like can be used as a material of the base portion 56 without using the metal. Furthermore, the elastic layers 57a and 57b are made of a normally used blanket material, configured so that a set of or a plurality of sets of a fabric backing layer, a foam layer (a compressive layer), and a rubber layer are superimposed, and this rubber layer is arranged on a surface side.

In this case, the two elastic layers 57a and 57b identical in length are bonded onto the surface of the base portion 56 at a predetermined interval by adhesive, and seal materials 58 are bonded between the base portion 56 and end portions of the respective elastic layers 57a and 57b. Accordingly, the concave portion 55 along a width direction is formed between the elastic layers 57a and 57b, and the blanket 52 is manufactured. Note that the seal materials 58 prevent the elastic layers 57a and 57b from being released from the base portion 56. The clamped portions 52a and 52b can be formed on the base portion 56 either in advance or last.

While only one blanket cylinder 21 and one plate cylinder 22 of each of the printing units 16 have been described here, the other blanket cylinder 31 and the other plate cylinder 32 are identical in configuration. Furthermore, other stacks of each printing unit 16 are identical in configuration and other printing units 16 and 17 are identical in configuration.

In the first embodiment described above, each of the printing units is configured to include the plate cylinder 22 to which the plate 42 is attached and the blanket cylinder 21 to which the blanket 52 is attached, that rotates synchronously with the plate cylinder 22, and that can transfer the ink image transferred from the plate cylinder 22 onto each web W. The circumference of the blanket cylinder 21 is set to be twice as large as that of the plate cylinder 22, and the notch 53 and the concave portion 55 along the axial direction are provided on the surface of the blanket 52 at a uniform interval to correspond to the notch 43 of the plate cylinder 22.

Therefore, when the plate cylinder 22 and the blanket cylinder 21 rotate, the notch 43 of the plate cylinder 22 faces the notch 53 and the concave portion 55 of the blanket cylinder 21. It is thereby possible to suppress the ink residues from being transferred from the plate cylinder 22 onto the blanket cylinder 21, and to improve the printing quality.

According to the blanket cylinder 21 of the first embodiment, the longitudinal end portions of the sheet-like blanket 52 are clamped to the outer circumferential portion of the blanket-cylinder main body 51, and the notch 53 and the concave portion 55 are provided to correspond to the notch 43 of the plate cylinder 22. By using the notch 53 that accommodates the blanket clamping device 54 as one of the concave portions, it is possible to make the blanket cylinder 21 simple in configuration.

According to the blanket cylinder 21 of the first embodiment, the circumferential length of each of the notch 53 and the concave portion 55 is set larger than that of the notch 43 of the plate cylinder 22, the notch 43 of the plate cylinder 22 does not contact the outer circumferential surface of the blanket cylinder 21, and it is possible to suppress the ink residues from being transferred from the plate cylinder 22 onto the blanket cylinder 21.

According to the blanket 52 of the first embodiment, the blanket 52 has a sheet-like shape, the clamped portions 52a and 52b that can be clamped to the blanket cylinder 21 are provided in the longitudinal end portions, respectively, the concave portion 55 is provided at the longitudinal intermediate position, and this concave portion 55 can be easily formed.

According to a method of manufacturing the blanket 52 of the first embodiment, the two elastic layers 57a and 57b are provided on the surface of the base portion 56 that can be clamped to the blanket cylinder 21 at a predetermined interval, thereby forming the concave portion 55 along the width direction between the elastic layers 57a and 57b and manufacturing the blanket 52. Therefore, there is no need to machine the elastic layers 57a and 57b and the concave portion 55 can be easily formed.

### Second Embodiment

FIG. 5 is a schematic diagram of a printing blanket according to a second embodiment of the present invention. A blanket cylinder to which the printing blanket according to the present embodiment is attached and a plate cylinder have configurations substantially identical to those in the first embodiment, and thus are explained with reference to FIG. 1. Members having functions identical to those explained in the first embodiment are denoted by like reference signs and redundant explanations thereof will be omitted.

In the second embodiment, as shown in FIGS. 1 and 5, the plate cylinder 22 is configured so that the plate 42 is attached to the outer circumferential portion of the plate-cylinder main body 41, the notch 43 along the axial direction of the plate-cylinder main body 41 is formed in the outer circumferential portion, and the plate clamping device 44 is accommodated in this notch 43. Meanwhile, the blanket cylinder 21 is configured so that a blanket (a printing blanket) 61 is attached to the outer circumferential portion of the blanket-cylinder main body 51, the notch 53 along the axial direction is formed in the outer circumferential portion, and the blanket clamping device 54 is accommodated in this notch 53.

The circumference of this blanket cylinder 21 is set to be twice as large as that of the plate cylinder 22. The rotation phases of the blanket cylinder 21 and the plate cylinder 22 are set so that the notches 43 and 53 always match each other when the blanket cylinder 21 and the plate cylinder 22 rotate synchronously. Furthermore, a concave portion 64 along the axial direction is provided on a surface of the blanket 61 attached to the outer circumferential portion of the blanket cylinder 21 to correspond to the position of the plate cylinder 22 at which the plate 42 is clamped, that is, to correspond to the notch 43.

That is, because of the setting of the circumference of the blanket cylinder 21 to be twice as large as that of the plate cylinder 22, when the blanket cylinder 21 rotates once, the plate cylinder 22 rotates twice. At this time, the notch 43 of the plate cylinder 22 arrives at the opposed position to the outer circumferential surface of the blanket cylinder 21 twice. Therefore, in the present embodiment, a plurality of concave portions are provided in the outer circumferential portion of the blanket cylinder 21 at a uniform interval to correspond to the notch 43 of the plate cylinder 22, thereby preventing the ink residues accumulated in the vicinity of the notch 43 of the plate cylinder 22 from being transferred onto the blanket cylinder 21. Specifically, the concave portion 64 is provided at a position at which the concave portion 64 faces this notch 53 circumferentially at the angle of 180 degrees with respect to the notch 53. Therefore, when the plate cylinder 22 and the blanket cylinder 21 synchronously rotate and the blanket cylinder 21 rotates once, the notch 53 and the concave portion 64 alternately face the notch 43 of the plate cylinder 22, thereby preventing the ink residues accumulated in the vicinity of the notch 43 of the plate cylinder 22 from being transferred onto the blanket cylinder 21.

The blanket 61 of the blanket cylinder 21 is described next in detail. As shown in FIG. 5, the concave portion 64 along the axial direction of the blanket-cylinder main body 51 is provided at a predetermined position of the surface of the blanket cylinder 21, that is, in the intermediate portion in the longitudinal direction (the direction of winding the blanket 61 around the blanket-cylinder main body 51 by one turn) in the present embodiment.

Specifically, the blanket 61 includes a base portion 62 that can be clamped to the blanket-cylinder main body 51, and one elastic layer 63 provided on a surface of this base portion 56. The concave portion 64 is provided on a surface of a longitudinal intermediate portion of this elastic layer 63. Furthermore, clamped portions 62a and 62b that are clamped to the blanket-cylinder main body 51 are formed in longitudinal end portions of the base portion 62, respectively.

In this case, the elastic layer 63 is bonded onto the surface of the base portion 62 by adhesive. The concave portion 64 is formed by partially cutting off this elastic layer at a longitudinal predetermined position, that is, the longitudinal intermediate position in the present embodiment by a predetermined thickness while leaving a desired thickness along a width direction. Seal materials 65 are bonded between the base portion 62 and end portions of the elastic layer 63, respectively, thereby manufacturing the blanket 61.

As described above, in the second embodiment, the circumference of the blanket cylinder 21 is set to be twice as large as that of the plate cylinder 22, and the notch 53 and the concave portion 64 along the axial direction are provided on the surface of the blanket 61 at a uniform interval to correspond to the notch 43 of the plate cylinder 22. Accordingly, when the plate cylinder 22 and the blanket cylinder 21 rotate, the notch 43 of the plate cylinder 22 faces the notch 53 and the concave portion 64 of the blanket cylinder 21. It is thereby possible to suppress the ink residues from being transferred from the plate cylinder 22 onto the blanket cylinder 21, and to improve the printing quality.

According to the blanket 61 of the second embodiment, the blanket 61 includes the base portion 62 that can be clamped to the blanket-cylinder main body 51 and the elastic layer 63 that is provided on the surface of this base portion 62, and the concave portion 64 is provided on the surface of this elastic layer 63. Therefore, the base portion 62 can ensure a predetermined rigidity, and the elastic layer 63 can ensure ink transfer characteristics. Furthermore, by providing the concave portion 64 on the surface of this elastic layer 63, the concave portion 64 can be formed with high positioning accuracy. In addition, because the elastic layer 63 is constituted out of one member, it is possible to suppress the elastic layer 63 from being released from the base portion 62.

According to a method of manufacturing the blanket 61 of the second embodiment, the elastic layer 63 is provided on the surface of the base portion 62 that can be clamped to the blanket-cylinder main body 51, and this elastic layer 63 is cut off at a predetermined longitudinal position in a width direction, thereby forming the concave portion 64 and manufacturing the blanket 61.

### Third Embodiment

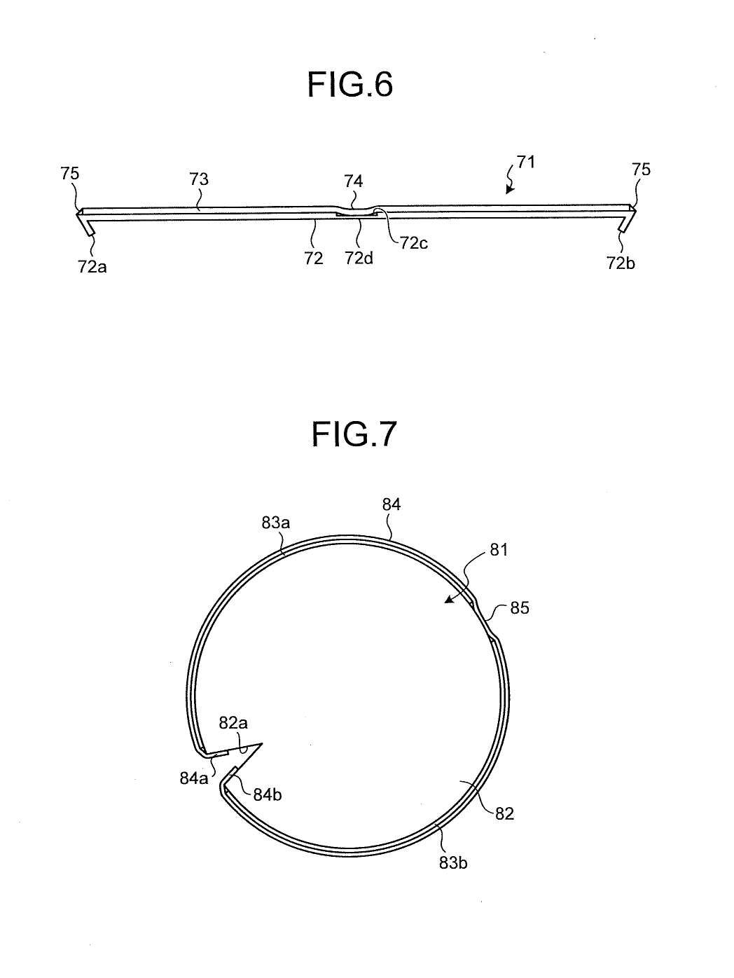

FIG. 6 is a schematic diagram of a printing blanket according to a third embodiment of the present invention. A blanket cylinder to which the printing blanket according to the present embodiment is attached and a plate cylinder have configurations substantially identical to those in the first embodiment, and thus are explained with reference to FIG. 1. Members having functions identical to those explained in the first embodiment are denoted by like reference signs and redundant explanations thereof will be omitted.

In the third embodiment, as shown in FIGS. 1 and 6, the plate cylinder 22 is configured so that the plate 42 is attached to the outer circumferential portion of the plate-cylinder main body 41, the notch 43 along the axial direction of the plate-cylinder main body 41 is formed in the outer circumferential portion, and the plate clamping device 44 is accommodated in this notch 43. The blanket cylinder 21 is configured so that a blanket (a printing blanket) 71 is attached to the outer circumferential portion of the blanket-cylinder main body 51, the notch 53 along the axial direction is formed in the outer circumferential portion, and the blanket clamping device 54 is accommodated in this notch 53.

The circumference of this blanket cylinder 21 is set to be twice as large as that of the plate cylinder 22. The rotation phases of the blanket cylinder 21 and the plate cylinder 22 are set so that the notches 43 and 53 always match each other when the blanket cylinder 21 and the plate cylinder 22 rotate synchronously. Furthermore, a concave portion 74 along the axial direction is provided on a surface of the blanket 71 attached to the outer circumferential portion of the blanket cylinder 21 to correspond to the position of the plate cylinder 22 at which the plate 42 is clamped, that is, to correspond to the notch 43.

That is, because of the setting of the circumference of the blanket cylinder 21 to be twice as large as that of the plate cylinder 22, when the blanket cylinder 21 rotates once, the plate cylinder 22 rotates twice. At this time, the notch 43 of the plate cylinder 22 arrives at the opposed position to the outer circumferential surface of the blanket cylinder 21 twice. Therefore, in the present embodiment, a plurality of concave portions are provided in the outer circumferential portion of the blanket cylinder 21 at a uniform interval to correspond to the notch 43 of the plate cylinder 22, thereby preventing the ink residues accumulated in the vicinity of the notch 43 of the plate cylinder 22 from being transferred onto the blanket cylinder 21. Specifically, the concave portion 74 is provided at a position at which the concave portion 74 faces the notch 53 circumferentially at the angle of 180 degrees with respect to the notch 53. Therefore, when the plate cylinder 22 and the blanket cylinder 21 synchronously rotate and the blanket cylinder 21 rotates once, the notch 53 and the concave portion 64 alternately face the notch 43 of the plate cylinder 22, thereby preventing the ink residues accumulated in the vicinity of the notch 43 of the plate cylinder 22 from being transferred onto the blanket cylinder 21.

The blanket 71 of the blanket cylinder 21 is described next in detail. As shown in FIG. 6, the concave portion 74 along the axial direction of the blanket-cylinder main body 51 is provided at a predetermined position of the surface of the blanket cylinder 21, that is, in the intermediate portion in the longitudinal direction (the direction of winding the blanket 71 around the blanket-cylinder main body 51 by one turn) in the present embodiment.

Specifically, the blanket 71 includes a base portion 72 that can be clamped to the blanket-cylinder main body 51, and one elastic layer 73 provided at a predetermined interval on a surface of this base portion 56 in the longitudinal direction. The concave portion 74 is provided on a surface of a longitudinal intermediate portion of this elastic layer 73. That is, clamped portions 72a and 72b to be clamped to the blanket-cylinder main body 51 are formed in longitudinal end portions of the base portion 72, respectively, and a concave portion 72c is formed on the surface of the longitudinal intermediate position, thereby forming a thin-walled portion 72d. By bonding the elastic layer 73 on the surface of the base portion 72 by adhesive, the thin-walled portion 72d causes the elastic layer 73 to deform to enter into the concave portion 72c and the concave portion 74 is formed. Thereafter, seal materials 75 are bonded between the base portion 72 and end portions of the elastic layers, respectively, thereby manufacturing the blanket 71.

As described above, in the third embodiment, the circumference of the blanket cylinder 21 is set to be twice as large as that of the plate cylinder 22, and the notch 53 and the concave portion 74 along the axial direction are provided on the surface of the blanket 71 at a uniform interval to correspond to the notch 43 of the plate cylinder 22. Accordingly, when the plate cylinder 22 and the blanket cylinder 21 rotate, the notch 43 of the plate cylinder 22 faces the notch 53 and the concave portion 74 of the blanket cylinder 21. It is thereby possible to suppress the ink residues from being transferred from the plate cylinder 22 onto the blanket cylinder 21, and to improve the printing quality.

According to the blanket 71 of the third embodiment, the blanket 71 includes the base portion 72 that can be clamped to the blanket-cylinder main body 51 and the elastic layer 73 that is provided on the surface of this base portion 72, the thin-walled portion 72d is provided at a predetermined position of the base portion 72, and the thin-walled portion 72d causes the elastic layer 73 to deform to thereby form the concave portion 74. Therefore, by forming the concave portion 74 in the elastic layer 73 by the use of the thin-walled portion 72d of the base portion 72, the concave portion 74 can be easily formed without changing a shape of the elastic layer 73, and the durability of the elastic layer 73 can be improved.

### Fourth Embodiment

FIG. 7 is a schematic side view of a blanket cylinder according to a fourth embodiment of the present invention.

In the fourth embodiment, as shown in FIG. 7, a blanket cylinder 81 is configured so that a blanket (a printing blanket) 84 is attached to an outer circumferential portion of a blanket-cylinder main body 82 via a plurality of (two in the present embodiment) films (sheets) 83a and 83b, a notch 82a along an axial direction is formed in the outer circumferential portion, and that a blanket clamping device (not shown) is accommodated in this notch 82a. A material of these films 83a and 83b is preferably, for example, a metal material, a plastic material, nylon (polyamide synthetic fiber), or fiber.

A circumference of this blanket cylinder 81 is set to be twice as large as that of a plate cylinder (not shown). Rotation phases of the blanket cylinder 81 and the plate cylinder are set so that the notch 82a of the blanket cylinder 81 always matches a notch of the plate cylinder when the blanket cylinder 81 and the plate cylinder rotate synchronously. In the blanket cylinder 81, a concave portion 85 along the axial direction is provided on a surface of the blanket 84 attached to the outer circumferential portion of the blanket cylinder 81 to correspond to a position of the plate cylinder at which a plate is clamped, that is, to correspond to the notch of the plate cylinder.

That is, because of the setting of the circumference of the blanket cylinder 81 to be twice as large as that of the plate cylinder, when the blanket cylinder 81 rotates once, the plate cylinder rotates twice. At this time, the notch of the plate cylinder arrives at an opposed position to an outer circumferential surface of the blanket cylinder 81 twice. Therefore, in the present embodiment, a plurality of concave portions are provided in the outer circumferential portion of the blanket cylinder 81 at a uniform interval to correspond to the notch of the plate cylinder, thereby preventing the ink residues accumulated in the vicinity of the notch of the plate cylinder from being transferred onto the blanket cylinder 81. Specifically, the concave portion 85 is provided at the position at which the concave portion 85 faces this notch 82a circumferentially at the angle of 180 degrees with respect to the notch 82a. Therefore, when the plate cylinder and the blanket cylinder 81 synchronously rotate and the blanket cylinder 81 rotates once, the notch 82a and the concave portion 85 alternately face the notch of the plate cylinder, thereby preventing the ink residues accumulated in the vicinity of the notch of the plate cylinder from being transferred onto the blanket cylinder 81.

The blanket cylinder 81 is described next in detail. The two films 83a and 83b are bonded onto the outer circumferential portion of the blanket-cylinder main body 82 at a predetermined gap therebetween in the circumferential direction by adhesive. The blanket 84 is attached to the surface of these films 83a and 83b, and the blanket clamping device accommodated in the notch 82a clamps clamped portions 83a and 84b. Accordingly, the gap between the two films 83a and 83b causes the blanket 84 to deform toward a center of the blanket-cylinder main body 82, thereby forming the concave portion 85. In this case, because the films 83a and 83b are identical in longitudinal length, the concave portion 85 is provided on a surface of a longitudinal intermediate portion of the blanket 84.

As described above, in the fourth embodiment, the circumference of the blanket cylinder 81 is set to be twice as large as that of the plate cylinder, and the notch 82a and the concave portion 85 along the axial direction are provided on the surface of the blanket 84 at a uniform interval to correspond to the notch of the plate cylinder. Accordingly, when the plate cylinder and the blanket cylinder 81 rotate, the notch of the plate cylinder faces the notch 82a and the concave portion 85 of the blanket cylinder 81. It is thereby possible to suppress the ink residues from being transferred from the plate cylinder onto the blanket cylinder 81, and to improve the printing quality.

According to the blanket cylinder 81 of the fourth embodiment, the films 83a and 83b are attached to the outer circumferential portion of the blanket-cylinder main body 82 at a predetermined gap therebetween, the blanket 84 is attached to the surface of these films 83a and 83b, and the gap between the films 83a and 83b causes the blanket 84 to deform to form the concave portion 85. Therefore, by forming the concave portion 85 in the blanket 84 by the use of the gap between the films 83a and 83b, the concave portion 85 can be easily formed without changing a shape of the blanket 84, and the durability of the blanket 84 can be improved.

In this fourth embodiment, the films 83a and 83b are designed to make a fine adjustment of an outside diameter of the blanket cylinder 81 and to adjust the nip between the blanket cylinder 81 and the plate cylinder. However, the films 83a and 83b are not limited to those described here and simple sheets can be used as the films 83a and 83b.

### Fifth Embodiment

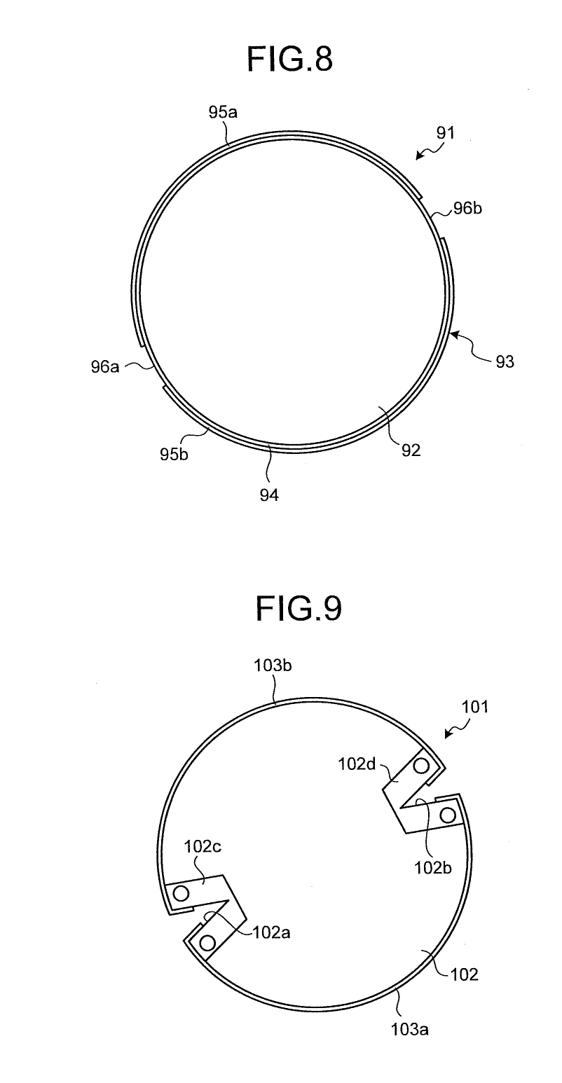

FIG. 8 is a schematic side view of a blanket cylinder according to a fifth embodiment of the present invention.

In the fifth embodiment, as shown in FIG. 8, a blanket cylinder 91 is configured so that a blanket (a printing blanket) 93 is attached to an outer circumferential portion of a blanket-cylinder main body 92. This blanket 93 has a cylindrical shape, and functions as a clamped portion that can be fitted into and clamped to an outer circumferential surface of the blanket-cylinder main body 92. Specifically, the blanket-cylinder main body 92 includes a main body portion and a small-diameter portion smaller than this main body portion, and air outlet holes are formed in an outer circumferential surface of this small-diameter portion. Accordingly, after the blanket 93 is inserted into the small-diameter portion of the blanket-cylinder main body 92, the air is blown out from the air outlet holes, thereby pressing the blanket 93 from inside and increasing a diameter of the blanket 93. In this state, the blanket 93 is inserted into the main body portion and the air blow-off from the air outlet holes is stopped, thereby reducing the diameter of the blanket 93 and fitting the blanket 93 into the blanket-cylinder main body 92 (a main body portion). As described above, the blanket 93 is clamped to the outer circumferential surface of the blanket-cylinder main body 92.

A circumference of this blanket cylinder 91 is set to be twice as large as that of a plate cylinder (not shown), and two concave portions 96a and 96b are circumferentially provided at a uniform interval on a surface of the blanket cylinder 91. Rotation phases of the blanket cylinder 91 and the plate cylinder are set so that a notch of the plate cylinder always matches the concave portions 96a and 96b when the blanket cylinder 91 and the plate cylinder rotate synchronously. In this case, the concave portions 96a and 96b along an axial direction are provided on the surface of the blanket 93 attached to the outer circumferential portion of the blanket cylinder 91 to correspond to a position of the plate cylinder at which a plate is clamped, that is, to correspond to the notch of the plate cylinder.

That is, because of the setting of the circumference of the blanket cylinder 91 to be twice as large as that of the plate cylinder, when the blanket cylinder 91 rotates once, the plate cylinder rotates twice. At this time, the notch of the plate cylinder arrives at an opposed position to an outer circumferential surface of the blanket cylinder 91 twice. Therefore, in the present embodiment, the two concave portions 96a and 96b are provided in the outer circumferential portion of the blanket cylinder 91 at a uniform interval to correspond to the notch of the plate cylinder, thereby preventing the ink residues accumulated in the vicinity of the notch of the plate cylinder from being transferred onto the blanket cylinder 91. Specifically, the two concave portions 96a and 96b are provided at positions at which the concave portions 96a and 96b face each other circumferentially at the angle of 180 degrees with respect to each other. Therefore, when the plate cylinder and the blanket cylinder 91 synchronously rotate and the blanket cylinder 91 rotates once, the concave portions 96a and 96b alternately face the notch of the plate cylinder, thereby preventing the ink residues accumulated in the vicinity of the notch of the plate cylinder from being transferred onto the blanket cylinder 91.

The blanket 93 of the blanket cylinder 91 is described next in detail. The blanket 93 includes a cylindrical base portion 94 that can be clamped to the blanket-cylinder main body 92, and two elastic layers 95a and 95b that are provided longitudinally on a surface of this base portion 94 at a predetermined interval. The concave portions 96a and 96b are provided in both longitudinal end portions of each of these elastic layers 95a and 95b, respectively.

As described above, in the fifth embodiment, the circumference of the blanket cylinder 91 is set to be twice as large as that of the plate cylinder, and the concave portions 96a and 96b along the axial direction are provided on the surface of the blanket 93 at a uniform interval to correspond to the notch of the plate cylinder. Accordingly, when the plate cylinder and the blanket cylinder 91 rotate, the notch of the plate cylinder faces the concave portions 96a and 96b of the blanket cylinder 91. It is thereby possible to suppress the ink residues from being transferred from the plate cylinder onto the blanket cylinder 91, and to improve the printing quality.

According to the blanket cylinder 91 of the fifth embodiment, the cylindrical blanket 93 is fitted into and clamped to the outer circumferential portion of the blanket-cylinder main body 92, and the two concave portions 96a and 96b are provided on the surface of the blanket 93. Therefore, it is possible to easily form the concave portions 96a and 96b on the blanket cylinder 91.

### Sixth Embodiment

FIG. 9 is a schematic side view of a blanket cylinder according to a sixth embodiment of the present invention.

In the sixth embodiment, as shown in FIG. 9, a blanket cylinder 101 is configured so that a plurality of (two in the present embodiment) blankets (printing blankets) 103a and 103b are attached to an outer circumferential portion of a blanket-cylinder main body 102. Two notches 102a and 102b are formed at a uniform interval in the outer circumferential portion of this blanket-cylinder main body 102 along a circumferential direction and an axial direction, and blanket clamping devices 102c and 102d are accommodated in these notches 102a and 102b, respectively. The blankets 103a and 103b are attached to the blanket-cylinder main body 102 by clamping clamped portions provided in end portions of the blankets 103a and 103b by the corresponding blanket clamping devices 102c and 102d, respectively.

In this case, a circumference of this blanket cylinder 101 is set to be twice as large as that of a plate cylinder (not shown). Rotation phases of the blanket cylinder 101 and the plate cylinder are set so that the notch 102a and 102b of the blanket cylinder 101 always match a notch of the plate cylinder when the blanket cylinder 101 and the plate cylinder rotate synchronously.

That is, because of the setting of the circumference of the blanket cylinder 101 to be twice as large as that of the plate cylinder, when the blanket cylinder 101 rotates once, the plate cylinder rotates twice. At this time, the notch of the plate cylinder arrives at an opposed position to an outer circumferential surface of the blanket cylinder 101 twice. Therefore, in the present embodiment, the two notches 102a and 102b are provided in the outer circumferential portion of the blanket cylinder 101 at a uniform interval to correspond to the notch of the plate cylinder, thereby preventing the ink residues accumulated in the vicinity of the notch of the plate cylinder from being transferred onto the blanket cylinder 101.

As described above, in the sixth embodiment, the circumference of the blanket cylinder 101 is set to be twice as large as that of the plate cylinder, the two notches 102a and 102b along the axial direction are provided at a uniform interval to correspond to the notch of the plate cylinder, and these notches 102a and 102b accommodate therein the blanket clamping devices 102c and 102d that clamp the respective blankets 103a and 103b. Accordingly, when the plate cylinder and the blanket cylinder 101 rotate, the notch of the plate cylinder faces the notches 102a and 102b of the blanket cylinder 101. It is thereby possible to suppress the ink residues from being transferred from the plate cylinder onto the blanket cylinder 101, and to improve the printing quality.

In the above embodiments, it has been described that the circumference of the blanket cylinder is set to be twice as large as that of the plate cylinder. However, the present invention is not limited to this configuration, but can be also applied in a case where the circumference of the blanket cylinder is set to the integer multiple of that of the plate cylinder, and the circumference of the blanket cylinder can be set to, for example, three times or four times as large as that of the plate cylinder. In this case, it suffices to set the number of concave portions in proportion to the circumference of the blanket cylinder and to provide a plurality of concave portions at a uniform interval circumferentially.

While an example in which the printing press according to the present invention is applied to a newspaper web offset printing press has been explained above, the printing press can be also applied to a commercial web offset printing press.

### INDUSTRIAL APPLICABILITY

The printing blanket, the manufacturing method of the printing blanket, the blanket cylinder, and the printing press according to the present invention suppresses transfer of ink residues from a plate cylinder onto the blanket cylinder by provision of a concave portion at a predetermined position on a surface of the printing blanket, thereby improving the printing quality, and can be applied to any types of printing press.

### REFERENCE SIGNS LIST

11 feeder device
12 printing device
13 turn bar device
14 folding machine
16, 17 printing unit
21, 31, 81, 91, 101 blanket cylinder
22, 32 plate cylinder
41 plate-cylinder main body
42 plate
43 notch
44 plate clamping device
51, 82, 92, 102 blanket-cylinder main body
52, 61, 71, 84, 93, 103a, 103b blanket
53, 102a, 102b notch (concave portion)
54, 102c, 102d blanket clamping device
55, 64, 74, 85, 96a, 96b concave portion
56, 62, 72, 94 base portion
57a, 57b, 63, 73, 95a, 95b elastic layer
58, 65, 75 seal material
83a, 83b film
W web (printing medium)

1. A printing blanket that is attached to an outer circumferential portion of a rotating body, and is capable of transfer an ink image onto a printing medium, comprising
a concave portion disposed along an axial direction of the rotating body at a predetermined position on a surface of the printing blanket.

2. The printing blanket according to claim 1, wherein the printing blanket has a sheet-like shape and includes a clamped portion that can be clamped to the rotating body and that is provided in each end portion of the printing blanket in a longitudinal direction, and the concave portion is provided at an intermediate position in the longitudinal direction or at a uniform interval position in the longitudinal direction.

3. The printing blanket according to claim 1, wherein the printing blanket has a cylindrical shape and includes a clamped portion that can be fitted into and clamped to the rotating body, and a plurality of concave portions are provided on a surface of the printing blanket at a uniform interval in a circumferential direction.

4. The printing blanket according to claim 2, further comprising:
a base portion that can be clamped to the rotating body; and
an elastic layer provided on a surface of the base portion, wherein
the concave portion is provided on a surface of the elastic layer.

5. The printing blanket according to claim 2, further comprising:
a base portion that can be clamped to the rotating body; and
a plurality of elastic layers provided on a surface of the base portion at a predetermined interval in a longitudinal direction, wherein
the concave portion is provided among the elastic layers.

6. The printing blanket according to claim 2, further comprising:
a base portion that can be clamped to the rotating body; and
an elastic layer provided on a surface of the base portion, wherein
a thin-walled portion is provided at a predetermined position of the base portion, and
the thin-walled portion causes the elastic layer to deform, thereby forming the concave portion.

7. A method of manufacturing a printing blanket that is attached to an outer circumferential portion of a rotating body and is capable of transferring an ink image onto a printing medium, the method comprising:
providing an elastic layer on a surface of a base portion that can be clamped to the rotating body; and
cutting the elastic layer at a predetermined longitudinal position in a width direction, thereby forming a concave portion and manufacturing the printing blanket.

8. A method of manufacturing a printing blanket that is attached to an outer circumferential portion of a rotating body and is capable of transferring an ink image onto a printing medium, the method comprising
providing elastic layers on a surface of a base portion that can be clamped to the rotating body at a predetermined interval in a longitudinal direction, thereby forming a concave portion along a width direction and manufacturing the printing blanket.

9. A blanket cylinder that rotates synchronously with a plate cylinder, is capable of transferring an ink image transferred from the plate cylinder onto a printing medium, and has a circumference set to an integer multiple of a circumference of the plate cylinder, comprising
a plurality of concave portions disposed along an axial direction are provided on a surface of the blanket cylinder at a uniform interval to correspond to a position of the plate cylinder at which a plate is clamped.

10. The blanket cylinder according to claim 9, wherein each longitudinal end portion of a sheet-like blanket is clamped to an outer circumferential portion of a blanket-cylinder main body, a clamping mechanism that clamps each end portion of the blanket to the blanket-cylinder main body is accommodated in at least one of the concave portions, and the remaining concave portions are provided on a surface of the blanket.

11. The blanket cylinder according to claim 9, wherein a cylindrical blanket is fitted in and clamped to an outer circumferential portion of a blanket-cylinder main body, and the concave portions are provided on a surface of the blanket.

12. The blanket cylinder according to claim 9, wherein a plurality of sheets are attached to an outer circumferential portion of a blanket-cylinder main body at a predetermined gap formed among the sheets in a circumferential direction, a blanket is attached to a surface of the sheets, and the gap among the sheets causes the blanket to deform, thereby forming the concave portions.

13. The blanket cylinder according to claim 1, wherein a circumferential length of each of the concave portions is set to be larger than a circumferential length of a notch formed in a plate clamped portion of the plate cylinder.

14. A printing press comprising:
a plate cylinder to which a plate is attached; and
a blanket cylinder that has a blanket attached thereto, rotates synchronously with the plate cylinder, and can transfer an ink image transferred from the plate cylinder onto a printing medium, wherein
a circumference of the blanket cylinder is set to an integer multiple of a circumference of the plate cylinder, and
a plurality of concave portions along an axial direction are provided on a surface of the blanket at a uniform interval to correspond to a position of the plate cylinder at which the plate is clamped.
